(19) United States
(12) Patent Application Publication
(10) Pub. No.: US 2021/0262893 A1
(43) Pub. Date: Aug. 26, 2021

(54) Auxiliary Detection And Failure Analysis System For Large Mechanical Device And Method Thereof

(71) Applicants: Inventec (Pudong) Technology Corporation, Shanghai (CN); Inventec Corporation, Taipei City (TW)

(72) Inventor: Chaucer Chiu, Taipei City (TW)

(21) Appl. No.: 16/899,426

(22) Filed: Jun. 11, 2020

(30) Foreign Application Priority Data
Feb. 24, 2020 (CN) 202010113036.6

(51) Int. Cl. G01M 13/00; G06K 9/00; G05B 23/02

(52) U.S. Cl. CPC G01M 13/00; H04L 67/12; G05B 23/0256; G06K 9/00671

(57) ABSTRACT

An auxiliary detection and failure analysis system for a large mechanical device and a method thereof are provided. In the system, an auxiliary detection device can provide maintenance staff with all detection process steps of the large mechanical device in augmented reality, a detection device can detect the large mechanical device to obtain detection data corresponding to the detection process steps, a server can store and analyze detection instruction information and the detection data, so as to find a faulty component of the large mechanical device and generate a maintenance suggestion, thereby achieving the technical effect of assisting in the maintenance of the large mechanical device to prevent maintenance omissions, and providing the maintenance suggestion.

### CROSS-REFERENCE TO RELATED APPLICATION

This application claims the benefit of Chinese Application Serial No. 202010113036.6, filed Feb. 24, 2020, which is hereby incorporated herein by reference in its entirety.

### BACKGROUND OF THE INVENTION

### 1. Field of the Invention

The present invention relates to an auxiliary detection and failure analysis system and a method thereof, and more particularly to an auxiliary detection and failure analysis system which can assist in the maintenance of a large mechanical device to prevent maintenance omissions and provide a maintenance suggestion, and a method thereof.

### 2. Description of the Related Art

When a large mechanical device is in need of maintenance, numerous detection process steps are required for maintenance of the large mechanical device, so it causes a huge maintenance cost and a long maintenance time in performing maintenance on the large mechanical device.

When maintenance staff makes an omission in the actual maintenance and detection of the large mechanical devices, a minor situation would be that the problem causing the failure of the large mechanical device may not be detected, and it leads to an increase in maintenance costs and maintenance time; and a severe situation would be that the omission may cause public safety accidents. Therefore, how to reduce the omissions of maintenance staff during maintenance and detection of a large mechanical device is a problem that needs to be solved.

In summary, there is a conventional technical problem that excessive detection process steps for the maintenance and detection of a large mechanical device may cause omissions easily, and it is necessary to propose improved technical solution to solve this problem.

### SUMMARY OF THE INVENTION

In order to solve the conventional technical problem that the excessive detection process steps for the maintenance and detection of a large mechanical device may cause omissions easily, the present invention provides an auxiliary detection and failure analysis system for a large mechanical device and a method thereof.

The present invention provides an auxiliary detection and failure analysis system for a large mechanical device, which is adapted to perform detection on the large mechanical device. The auxiliary detection and failure analysis system includes an auxiliary detection device, a detection device, and a server. The auxiliary detection device includes an image module, a first transmitting module, a receiving module and an augmented reality module. The detection device includes a detection module and a second transmitting module. The server includes a server receiving module, a storage module, a query module, a selection module, an analysis module and a server transmitting module.

The image module of the auxiliary detection device is configured to capture an information image having large mechanical device identification information. The first transmitting module of the auxiliary detection device is configured to transmit the information image. The receiving module of the auxiliary detection device is configured to receive detection instruction information correspond to each detection processing step orderly, and receive a name of a faulty component of the large mechanical device and a maintenance suggestion. The augmented reality module of the auxiliary detection device is configured to display the detection instruction information correspond to each detection processing step on a display image in augmented reality orderly, and display the name of the faulty component of the large mechanical device and the maintenance suggestion on the display image in augmented reality.

The detection module of the detection device is configured to detect the large mechanical device with reference to the detection instruction information correspond to each detection processing step, to obtain the detection data corresponding to the detection instruction information which correspond to each detection processing step, orderly. The second transmitting module of the detection device is configured to transmit the detected detection data which correspond to each detection processing step orderly.

The server receiving module of the server is configured to receive the information image from the first transmitting module, and receive the detected detection data which correspond to each detection processing step from the second transmitting module orderly. The query module of the server is configured to query the detection process steps corresponding to the large mechanical device identification information on the information image, and query the detection instruction information corresponding to each detection process step. The storage module is configured to store the detection instruction information and the detected detection data which correspond to each detection processing step according to the order of the detection processing steps. The selection module of the server is configured to select the detection instruction information corresponding to a first detection process step, and select the detection instruction information corresponding to the (N+1)th detection process step after the storage module stores the detection instruction information and the detected detection data which correspond to the Nth detection processing step, wherein the maximum value of (N+1) is the number of the detection processing steps, and N is an integer and greater than or equal to 1. The analysis module of the server is configured to analyze all the detection instruction information and all the detected detection data, to find the faulty component of the large mechanical device and generate the maintenance suggestion after the detection instruction information and the detected detection data corresponding to each detection process step are stored orderly in the storage module. The server transmitting module of the server is configured to transmit the detection instruction information which correspond to each detection processing step, which is selected by the selection module, to the receiving module orderly, and transmit the name of the faulty component of the large mechanical device and the maintenance suggestion, which are analyzed by the analysis module, to the receiving module.

Furthermore, the present invention also provides an auxiliary detection and failure analysis method for a large mechanical device, which is adapted to perform detection on the large mechanical device. The auxiliary detection and failure analysis method includes following steps: capturing, by an auxiliary detection device, an information image having large mechanical device identification information; transmitting, by the auxiliary detection device, the information image to a server; querying, by the server, detection process steps corresponding to the large mechanical device identification information on the information image and querying detection instruction information corresponding to each detection process step; selecting, by the server, the detection instruction information corresponding to a first detection process step; transmitting, by the server, the selected detection instruction information to the auxiliary detection device; displaying, by the auxiliary detection device, the selected detection instruction information on a display image in augmented reality; detecting, by a detection device with reference to the selected detection instruction information, the large mechanical device to obtain detection data corresponding to the selected detection instruction information; transmitting, by the detection device, the detected detection data corresponding to the selected detection instruction information to the server; storing, by the server, the detection instruction information and the detected detection data which correspond to the selected detection process step; selecting, by the server, the detection instruction information corresponding to the next detection process step; returning to the step of transmitting, by the detection device, the detected detection data corresponding to the selected detection instruction information to the server, until the server storing the detection instruction information and the detected detection data corresponding to all of the detection process steps; analyzing, by the server, the detection instruction information and the detected detection data, to find a faulty component of the large mechanical device and generate a maintenance suggestion; transmitting, by the server, a name of the faulty component of the large mechanical device and the maintenance suggestion, which are analyzed by the analysis module, to the auxiliary detection device; and displaying, by the auxiliary detection device, the name of the faulty component of the large mechanical device and the maintenance suggestion on the display image in augmented reality.

According to above-mentioned contents, the difference between the system and method of the present invention and the conventional technology is that the auxiliary detection device can provide maintenance staff with the detection process steps of the large mechanical device in augmented reality, the detection device can detect the large mechanical device to obtain the detection data corresponding to the detection process steps, the server can store and analyze the detection instruction information and the detection data, to obtain the faulty component of the large mechanical device and generate the maintenance suggestion.

By the above-mentioned technical solution, the present invention can achieve the technical effect of assisting in the maintenance of the large mechanical device to prevent maintenance omissions, and providing the maintenance suggestion.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of an auxiliary detection and failure analysis system for a large mechanical device, according to the present invention.

FIG. 2 is a schematic view of an information image of the auxiliary detection and failure analysis system for the large mechanical device, according to the present invention.

FIGS. 3 to 5 are schematic views of a display image of the auxiliary detection and failure analysis system for the large mechanical device, according to the present invention.

FIGS. 6A to 6C are flowcharts of an auxiliary detection and failure analysis method for a large mechanical device, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

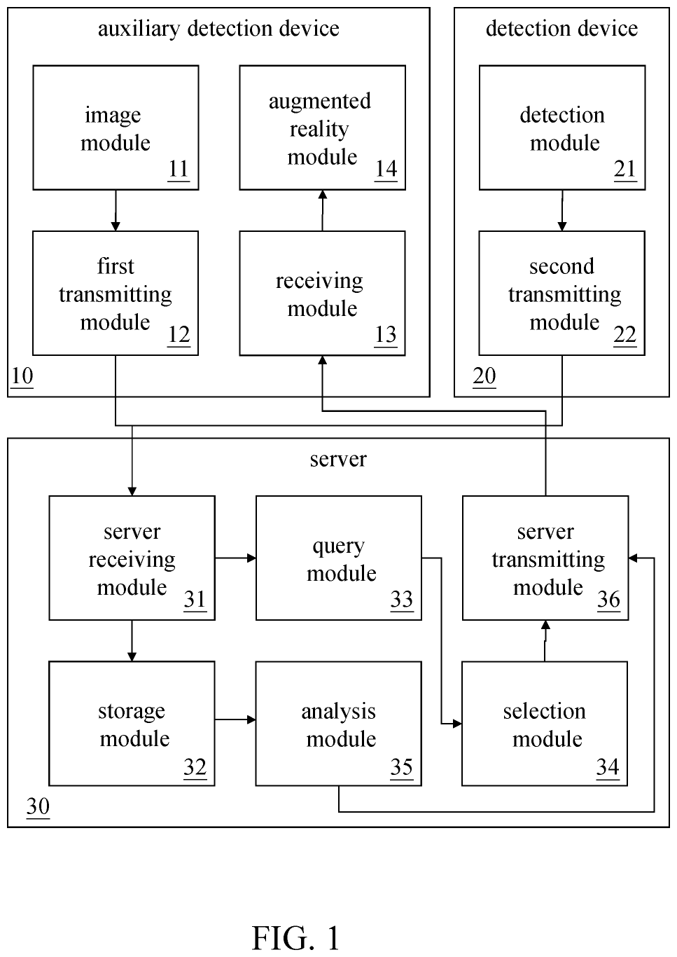

An auxiliary detection and failure analysis system of the present invention would be described in the following paragraphs. Please refer to FIG. 1, which is a system block diagram of an auxiliary detection and failure analysis system for a large mechanical device, according to the present invention.

As shown in FIG. 1, the auxiliary detection and failure analysis system for the large mechanical device is adapted to perform detection on the large mechanical device, for example, the large mechanical device can be a turning machine, a milling machine, a grinder, a cutting machine, an electroplating machine, an etching machine, or air conditioning equipment; however, these examples are merely for exemplary illustration, and the application field of the present invention is not limited thereto. The auxiliary detection and failure analysis system for the large mechanical device includes an auxiliary detection device 10, a detection device 20, and a server 30. The auxiliary detection device 10 includes an image capture module 11, a first transmitting module 12, a receiving module 13 and a augmented reality module 14. The detection device 20 includes a detection module 21 and a second transmitting module 22. The server 30 includes a server receiving module 31, a storage module 32, a query module 33, a selection module 34, an analysis module 35 and a server transmitting module 36.

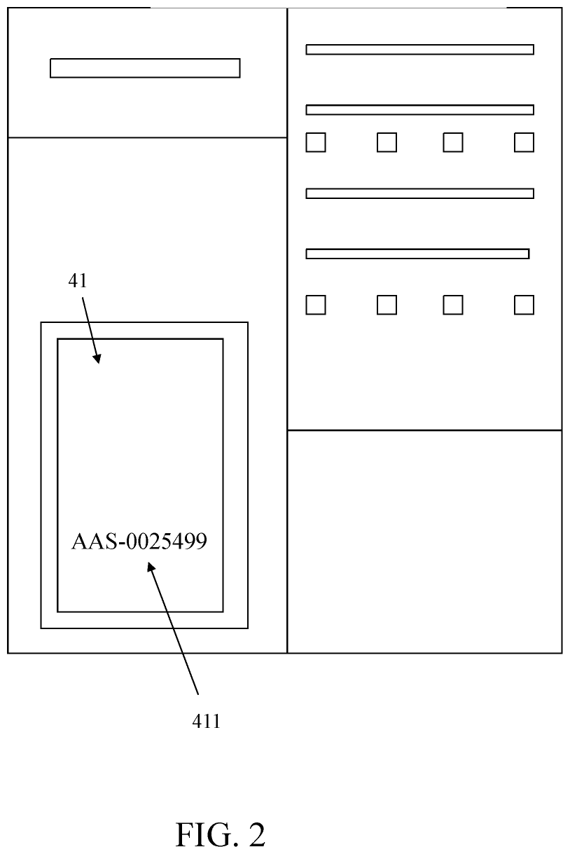

When the large mechanical device fails, the maintenance staff can use the image module 11 of the auxiliary detection device 10 to capture an information image 41 having large mechanical device identification information 411. In an embodiment, the auxiliary detection device 10 can be an electronic device with image capture function, for example, the auxiliary detection device 10 can be a smartphone, a tablet computer or a notebook computer; however, these examples are merely for exemplary illustration, and the application field of the present invention is not limited thereto. FIG. 2 is a schematic view of an information image of the auxiliary detection and failure analysis system for the large mechanical device, according to the present invention. FIG. 2 shows the aforementioned information image 41, and the large mechanical device identification information 411 is presented as a serial number; however, this example is merely for exemplary illustration, and in an embodiment, the large mechanical device identification information 411 can be presented in the form of text, and the application field of the present invention is not limited to above-mentioned examples.

The auxiliary detection device 10 can be linked to the server 30 through wireless transmission, such as Wi-Fi, mobile communication network (such as, 3G, 4G or 5G); however, these examples are merely for exemplary illustration, and the application field of the present invention is not limited to these examples. The first transmitting module 12 of the auxiliary detection device 10 can transmit the information image 41 to the server 30.

The server receiving module 31 of the server 30 can receive the information image 41 from the first transmitting module 12 of the auxiliary detection device 10, and the server 30 can recognize the large mechanical device identification information 411 on the information image 41 by text recognition technology. Since the text recognition technology is a well-known technology, the detailed description is not repeated herein.

The query module 33 of the server 30 can query detection process steps corresponding to the large mechanical device identification information 411 on the information image 41, and query the detection instruction information corresponding to each of the detection process steps. In an embodiment, the detection instruction information can include at least one of a detection position indication, a detection item indication and a detection operation indication; and the detection instruction information can be presented in the form of image, video or text; however, these examples are merely for exemplary illustration, and the application field of the present invention is not limited to these examples. For the maintenance staff, the detection instruction information indicates the detection, which should be performed in the detection process steps.

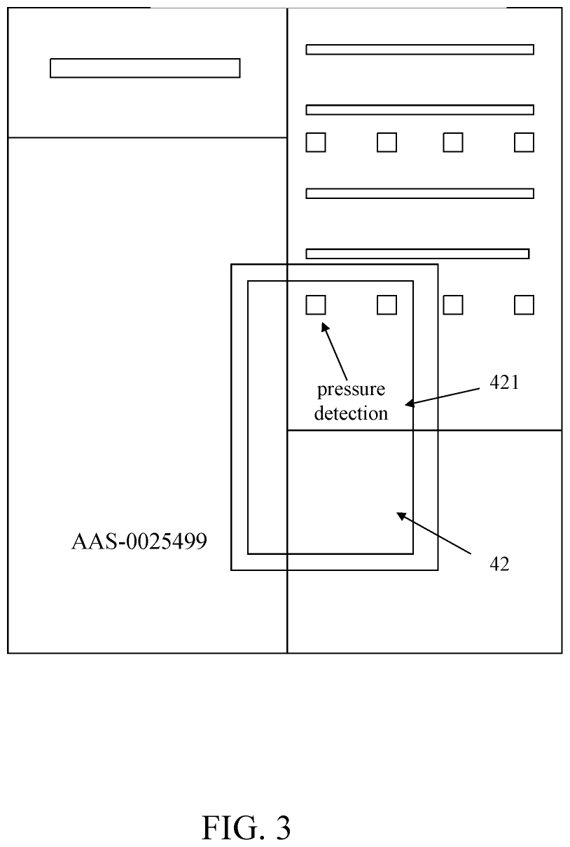

Next, the selection module 34 of the server 30 can select the detection instruction information corresponding to a first detection process step, and the server transmitting module 36 of the server 30 can transmit the detection instruction information, which is selected by the selection module 34 of the server 30, to the auxiliary detection device 10. The receiving module 13 of the auxiliary detection device 10 can receive the selected detection instruction information from the server transmitting module 36 of the server 30, and the augmented reality module 14 of the auxiliary detection device 10 can display the selected detection instruction information on the display image 42 in augmented reality. Please refer to FIG. 3, which is a schematic view of a display image of the auxiliary detection and failure analysis system for the large mechanical device, according to the present invention. The detection instruction information 421 of FIG. 3 is presented in a form of text, but this example is merely for exemplary illustration, and the way of presenting the detection instruction information 421 is not limited to the example.

Next, the operator can use the detection device 20 to perform detection on the large mechanical device based on the selected detection instruction information 421 displayed by the augmented reality module 14 of the auxiliary detection device 10, and the detection module 21 of the detection device 20 uses the corresponding detector to perform detection on the large mechanical device, so as to obtain the detection data corresponding to the selected detection instruction information 421; in an embodiment, the detection performed on the large mechanical device by the detection module 21 of the detection device 20 can include at least one of mechanical structure detection, mechanical assembly detection, voltage detection, current detection, pressure detection, temperature detection, conduction detection and residual volume detection; however, these examples are merely for exemplary illustration, and the application field of the present invention is not limited thereto.

The detection device 20 can be linked with the server 30 through wireless transmission, such as Wi-Fi, mobile communication network (such as 3G, 4G or 5G), but these examples are merely for exemplary illustration, and the application field of the present invention is not limited thereto. After the detection module 21 of the detection device 20 obtains the detection data corresponding to the selected detection instruction information 421 based on detection on the large mechanical device, the second transmitting module 22 of the detection device 20 can transmit the detection data corresponding to the selected detection instruction information 421 to the server 30.

The server receiving module 31 of the server 30 can receive the detection data corresponding to the selected detection instruction information 421 from the second transmitting module 22 of the detection device 20, and then the storage module 32 of the server 30 can store the detection instruction information and the detected detection data corresponding to the selected detection process step.

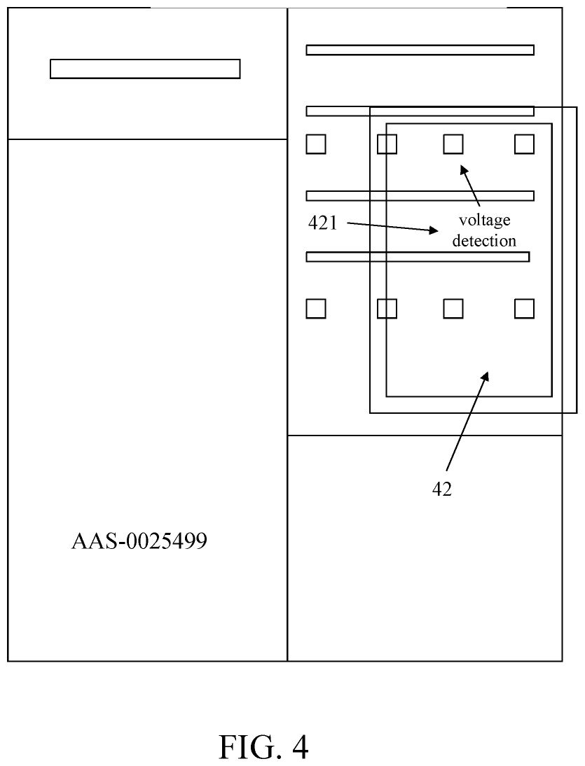

After the detection instruction information and the detected detection data corresponding to the selected detection process step is stored in the storage module 32 of the server 30, the selection module 34 of the server 30 selects the detection instruction information corresponding to the next detection process step (for example, in this embodiment, the selection module 34 selects the second detection process step), and then the server transmitting module 36 of the server 30 transmits the detection instruction information, which is selected by the selection module 34 of the server 30, to the auxiliary detection device 10, and the receiving module 13 of the auxiliary detection device 10 can then receive the selected detection instruction information from the server transmitting module 36 of the server 30. Next, the augmented reality module 14 of the auxiliary detection device 10 can display the selected detection instruction information 421 on the display image 42 in augmented reality, as shown in FIG. 4, which is a schematic view of the display image of the auxiliary detection and failure analysis system for the large mechanical device, according to the present invention.

It should be noted that after the selection module 34 of the server 30 selects the detection instruction information corresponding to the next detection process step, the system repeats the steps in which the server transmitting module 36 of the server 30 transmits the detection instruction information, which is selected by the selection module 34 of the server 30, to the auxiliary detection device 10, the receiving module 13 of the auxiliary detection device 10 can then receive the selected detection instruction information from the server transmitting module 36 of the server 30, the augmented reality module 14 of the auxiliary detection device 10 can display the selected detection instruction information 421 on the display image 42 in augmented reality, the detection module 21 of the detection device 20 obtains the detection data corresponding to the selected detection instruction information 421 based on detection on the large mechanical device, the second transmitting module 22 of the detection device 20 can transmit the detection data corresponding to the selected detection instruction information 421 to the server 30, the server receiving module 31 of the server 30 can receive the detection data corresponding to the selected detection instruction information 421 from the second transmitting module 22 of the detection device 20, and the storage module 32 of the server 30 can store the detection instruction information and the detected detection data corresponding to the selected detection process step, until the detection instruction information and the detected detection data corresponding to all of the detection process steps are stored in the storage module 32 of the server 30 orderly.

After the detection instruction information and the detected detection data corresponding to all of the detection process steps are stored in the storage module 32 of the server 30, the analysis module 35 of the server 30 analyzes all the detection instruction information and all the detected detection data, to find a faulty component of the large mechanical device and generate a maintenance suggestion.

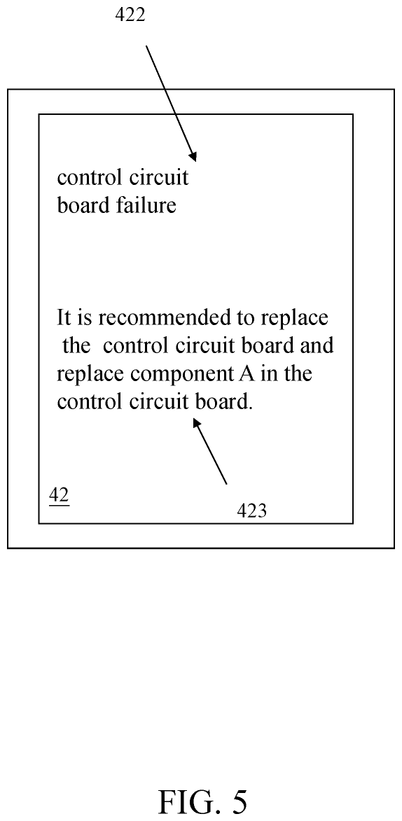

Next, the server transmitting module 36 of the server 30 can transmit a name of the faulty component of the large mechanical device and the maintenance suggestion to the auxiliary detection device 10, the receiving module 13 of the auxiliary detection device 10 can receive the name of the faulty component of the large mechanical device and the maintenance suggestion from the server transmitting module 36 of the server 30, and the augmented reality module 14 of the auxiliary detection device 10 displays the name of the faulty component of the large mechanical device 422 and the maintenance suggestion 423 on the display image 42 in augmented reality, as shown in FIG. 5, which is a schematic view of the display image of the auxiliary detection and failure analysis system for the large mechanical device, according to the present invention.

The query module 33 of the server 30 can query normal data range corresponding to each of the detection process steps, according to the large mechanical device identification information on the information image. When selecting the next detection process step, the selection module 34 of the server 30 selects the normal data range corresponding to the current detection process step, and the server transmitting module 36 of the server 30 can transmit the detection instruction information and the normal data range, which are selected by the selection module 34 of the server 30, to the auxiliary detection device 10.

The receiving module 13 of the auxiliary detection device 10 can receive the selected detection instruction information and the selected normal data range from the server transmitting module 36 of the server 30, and the augmented reality module 14 of the auxiliary detection device 10 can display the selected detection instruction information and the selected normal data range on the display image in augmented reality, thereby providing the maintenance staff the information about whether the detection data obtained by the detection performed on the large mechanical device by the detection device 20 is within the selected normal data range, in real time.

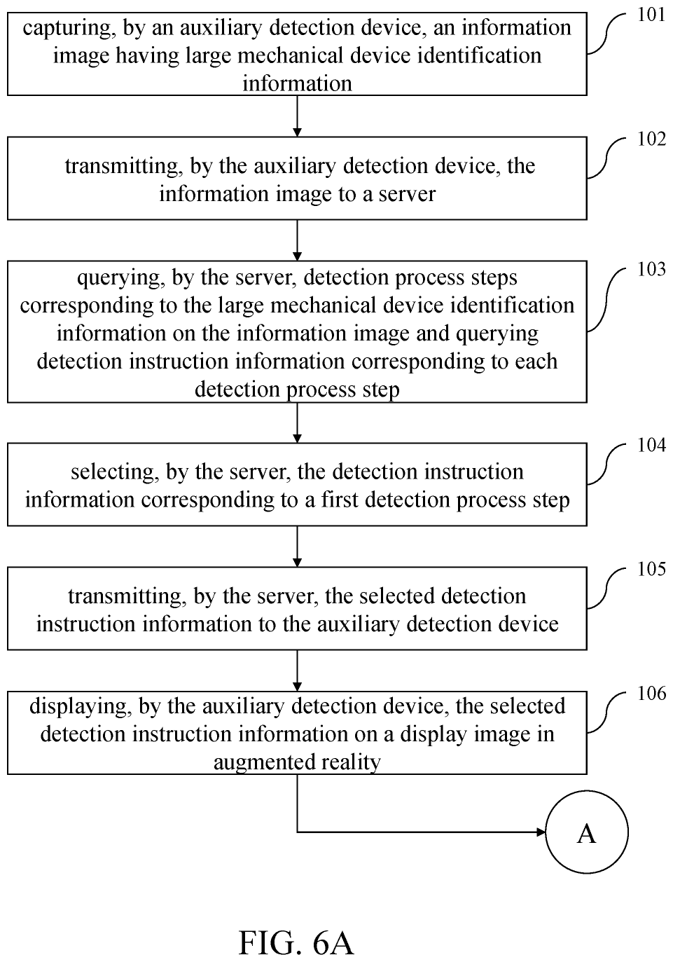

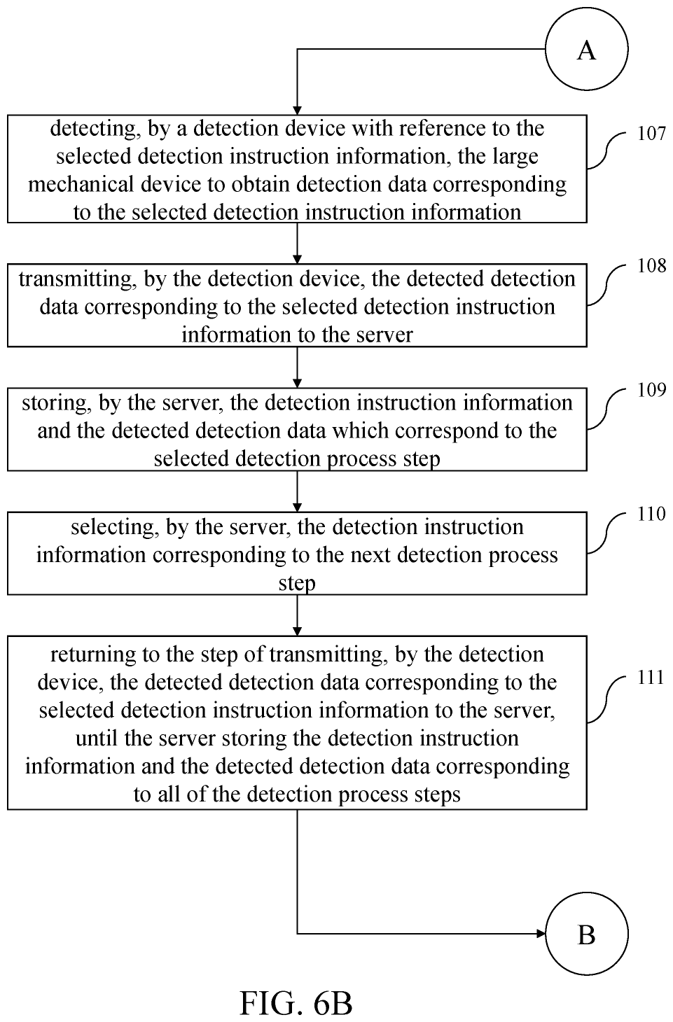

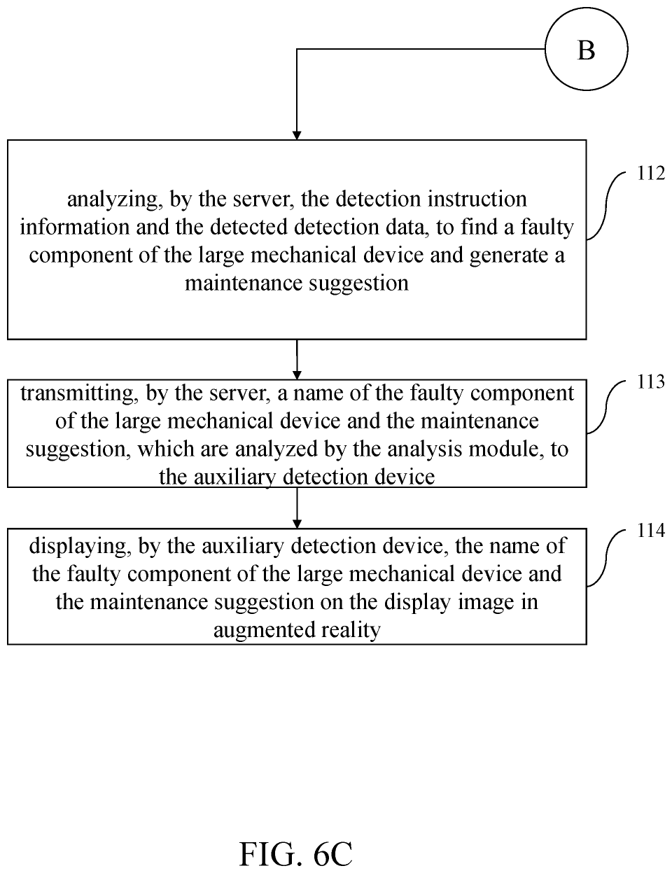

Please refer to FIGS. 6A to 6C, which are flowcharts of an auxiliary detection and failure analysis method for a large mechanical device, according to the present invention. The auxiliary detection and the failure analysis method for the large mechanical device includes following steps: capturing, by an auxiliary detection device, an information image having large mechanical device identification information (in the step 101); transmitting, by the auxiliary detection device, the information image to a server (in the step 102); querying, by the server, detection process steps corresponding to the large mechanical device identification information on the information image and querying detection instruction information corresponding to each detection process step (in the step 103); selecting, by the server, the detection instruction information corresponding to a first detection process step (in the step 104); transmitting, by the server, the selected detection instruction information to the auxiliary detection device (in the step 105); displaying, by the auxiliary detection device, the selected detection instruction information on a display image in augmented reality (in the step 106); detecting, by a detection device with reference to the selected detection instruction information, the large mechanical device to obtain detection data corresponding to the selected detection instruction information (in the step 107); transmitting, by the detection device, the detected detection data corresponding to the selected detection instruction information to the server (in the step 108); storing, by the server, the detection instruction information and the detected detection data which correspond to the selected detection process step (in the step 109); selecting, by the server, the detection instruction information corresponding to the next detection process step (in the step 110); returning to the step of transmitting, by the detection device, the detected detection data corresponding to the selected detection instruction information to the server, until the server storing the detection instruction information and the detected detection data corresponding to all of the detection process steps (in the step 111); analyzing, by the server, the detection instruction information and the detected detection data, to find a faulty component of the large mechanical device and generate a maintenance suggestion (in the step 112); transmitting, by the server, a name of the faulty component of the large mechanical device and the maintenance suggestion, which are analyzed by the analysis module, to the auxiliary detection device (in the step 113); and displaying, by the auxiliary detection device, the name of the faulty component of the large mechanical device and the maintenance suggestion on the display image in augmented reality (in the step 114).

According to the above-mentioned contents, the difference between the system and method of the present invention and the conventional technology is that the auxiliary detection device can provide maintenance staff with all detection process steps for the large mechanical device in augmented reality, the detection device is used to detect the large mechanical device to obtain the detection data corresponding to the detection process steps, the server can store the detection instruction information and the detection data for analysis, to find the faulty component of the large mechanical device and generate the maintenance suggestion.

Therefore, the technical solution of the present invention can solve the conventional technical problem that excessive detection process steps for the large mechanical device may cause omissions easily, thereby achieving the technical effect of assisting in the maintenance of the large mechanical device to prevent maintenance omissions and provide the maintenance suggestion.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An auxiliary detection and failure analysis system for a large mechanical device, adapted to perform detection on the large mechanical device, and the auxiliary detection and failure analysis system comprising:
an auxiliary detection device comprising:
an image module configured to capture an information image having large mechanical device identification information;
a first transmitting module configured to transmit the information image;
a receiving module configured to receive detection instruction information correspond to each detection processing step orderly, and receive a name of a faulty component of the large mechanical device and a maintenance suggestion; and
an augmented reality module configured to display the detection instruction information correspond to each detection processing step on a display image in augmented reality orderly, and display the name of the faulty component of the large mechanical device and the maintenance suggestion on the display image in augmented reality;
a detection device comprising
a detection module configured to detect the large mechanical device with reference to the detection instruction information correspond to each detection processing step, to obtain detection data corresponding to the detection instruction information which correspond to each detection processing step, orderly; and
a second transmitting module configured to transmit the detected detection data which correspond to each detection processing step orderly; and
a server comprising:
a server receiving module configured to receive the information image from the first transmitting module, and receive the detected detection data which correspond to each detection processing step from the second transmitting module orderly;
a query module configured to query the detection process steps corresponding to the large mechanical device identification information on the information image, and query the detection instruction information corresponding to each detection process step;
a storage module configured to store the detection instruction information and the detected detection data which correspond to each detection processing step according to the order of the detection processing steps;
a selection module configured to select the detection instruction information corresponding to a first detection processing step; and select the detection instruction information corresponding to the (N+1)th detection processing step after the storage module stores the detection instruction information and the detected detection data which correspond to the Nth detection processing step, wherein the maximum value of (N+1) is the number of the detection processing steps, and N is an integer and greater than or equal to 1;
an analysis module configured to after the detection instruction information and the detected detection data which correspond to each detection processing step are stored orderly in the storage module, analyze all the detection instruction information and all the detected detection data to find the faulty component of the large mechanical device and generate the maintenance suggestion; and
a server transmitting module configured to transmit the detection instruction information which correspond to each detection processing step, which is selected by the selection module, to the receiving module orderly, and transmit the name of the faulty component of the large mechanical device and the maintenance suggestion, which are analyzed by the analysis module, to the receiving module.

2. The auxiliary detection and failure analysis system according to claim 1, wherein the detection performed on the large mechanical device by the detection module comprises at least one of mechanical structure detection, mechanical assembly detection, voltage detection, current detection, pressure detection, temperature detection, conduction detection and residual volume detection.

3. The auxiliary detection and failure analysis system according to claim 1, wherein the detection instruction information comprises at least one of a detection position indication, a detection item indication, and a detection operation indication.

4. The auxiliary detection and failure analysis system according to claim 1, wherein in the auxiliary detection device, the receiving module further receives the detection instruction information and normal data range which correspond to each detection process step, the augmented reality module displays the detection instruction information and the normal data range which correspond to each detection process step on the display image in augmented reality; and
wherein in the server, the query module further queries the normal data range which correspond to each detection process step based on the large mechanical device identification information on the information image; when selecting the detection instruction information corresponding to the (N+1)th detection processing step, the selection module selects the normal data range corresponding to the Nth detection process step; and the server transmitting module transmits the detection instruction information and the normal data range which correspond to each detection processing step, which are selected by the selection module, to the receiving module orderly.

5. An auxiliary detection and failure analysis method for a large mechanical device, adapted to perform detection on the large mechanical device, and the auxiliary detection and failure analysis method comprising steps:
capturing, by an auxiliary detection device, an information image having large mechanical device identification information;
transmitting, by the auxiliary detection device, the information image to a server;
querying, by the server, detection process steps corresponding to the large mechanical device identification information on the information image and querying detection instruction information corresponding to each detection process step;
selecting, by the server, the detection instruction information corresponding to a first detection process step;
transmitting, by the server, the selected detection instruction information to the auxiliary detection device;
displaying, by the auxiliary detection device, the selected detection instruction information on a display image in augmented reality;
detecting, by a detection device with reference to the selected detection instruction information, the large mechanical device to obtain detection data corresponding to the selected detection instruction information;
transmitting, by the detection device, the detected detection data corresponding to the selected detection instruction information to the server;
storing, by the server, the detection instruction information and the detected detection data which correspond to the selected detection process step;
selecting, by the server, the detection instruction information corresponding to the next detection process step;
returning to the step of transmitting, by the detection device, the detected detection data corresponding to the selected detection instruction information to the server, until the server storing the detection instruction information and the detected detection data corresponding to all of the detection process steps;
analyzing, by the server, all the detection instruction information and all the detected detection data, to find a faulty component of the large mechanical device and generate a maintenance suggestion;
transmitting, by the server, a name of the faulty component of the large mechanical device and the maintenance suggestion, which are analyzed by the analysis module, to the auxiliary detection device; and
displaying, by the auxiliary detection device, the name of the faulty component of the large mechanical device and the maintenance suggestion on the display image in augmented reality.

6. The auxiliary detection and failure analysis method according to claim 5, wherein the detection performed on the large mechanical device by the detection device comprise at least one of mechanical structure detection, mechanical assembly detection, voltage detection, current detection, pressure detection, temperature detection, conduction detection and residual volume detection.

7. The auxiliary detection and failure analysis method according to claim 5, wherein the detection instruction information comprises at least one of a detection position indication, a detection item indication, and a detection operation indication.

8. The auxiliary detection and failure analysis method according to claim 5, further comprising:
querying, by the server, the normal data range corresponding to each of the detection process steps, according to the large mechanical device identification information on the information image;
selecting, by the server, the normal data range corresponding to the Nth detection process step when selecting, by the server, the detection instruction information corresponding to the (N+1)th detection processing step, wherein the maximum value of (N+1) is the number of the detection processing steps, and N is an integer and greater than or equal to 1;
transmitting, by the server, the selected detection instruction information and the selected normal data range to the auxiliary detection device; and
displaying, by the auxiliary detection device, the selected detection instruction information and the selected normal data range on the display image in augmented reality.
